(19) United States
(12) Patent Application Publication
(10) Pub. No.: US 2006/0042559 A1
(43) Pub. Date: Mar. 2, 2006

(54) Clipper for pet claws

(76) Inventor: Sung Boon Kang, Incheon (KR)

Correspondence Address: BACON & THOMAS, PLLC, 625 SLATERS LANE, FOURTH FLOOR, ALEXANDRIA, VA, 22314, US

(21) Appl. No.: 10/963,799

(22) Filed: Oct. 14, 2004

(30) Foreign Application Priority Data
Aug. 24, 2004 (KR) 2004-66842

(51) Int. Cl. A01K 13/00

(52) U.S. Cl. 119/600

(57) ABSTRACT

The invention relates to a clipper for a pet wherein the user may cut the claw of a pet conveniently and safely and may remove the clipped claw fragments clearly. The clipper includes a body having a handle shaft shape, a head which is positioned at the front portion of the body and a claw insertion hole at one side of the head. A cutting mechanism having fixed and movable cutters all fixed inside the head. A lever which is connected to the movable cutter diagonally extends toward the lower direction of the body through an opening 9 formed at the lower surface of the head, and an adjusting bolt screwed at the other side of the head opposite to the claw insertion hole adjustable to adjust the insertion length of the claw.

### FIELD OF THE INVENTION

The invention relates to a clipper for pet, and more particularly, relates to a clipper for pet wherein the user may cut the claw of a pet conveniently and safely and may remove the clipped claw fragments conveniently.

### BACKGROUND OF THE INVENTION

Previously, the inventor was inspired by a nail clipper for a person and created a clipper for pet (Korean Utility Model Registration No. 2000-9505375), which may clip the claw of a pet conveniently and safely. FIG. 1 and FIG. 2 show the above-mentioned prior art clipper for pet 1. As shown in FIGS. 1 and 2 of the drawings, a pair of cutters 5, 6 are positioned in the head 3 of the body 2 of a shaft shaped handle. And, among the cutters 5, 6, a fixed cutter element 5 is fixed in the body 5 and a rotating cutter element 6 is pivotally hinged on a hinge shaft 7 so as to be elastically biased by a spring 8. The rotating cutter 6 is rotated by a thumb lever 10 which extends through an opening 4 formed on the upper surface of the body 2. A claw insertion hole 12 for inserting the claw of the pet is formed at one side of the head 3 of the body 2, and an adjusting bolt 14 is screwed at the other side of the head 3 opposite to the claw insertion hole 12 so that the insertion depth of the claw in the hole may be adjusted by the adjusting bolt 14.

A battery chamber 18 is formed inside the center of the body 2 adjacent to the head 3, and a motor 20 is positioned in the body 2 and is electrically connected to a battery 16. A grinder 22 is positioned partly within and at the rear portion of the body 5 and is connected to the shaft of the motor 20. The grinder 22 is partially exposed through an opening 24 formed at the rear end of the body 5. A switch 26 for controlling operation of the motor 20 is mounted at one side of the outer periphery of the body 5. Further, the head 3 and the battery chamber 18 of the body 5 are covered together with one cover 19.

Accordingly, the user may adjust the insertion length of the adjusting bolt 14 and insert the claw of the pet between the fixing and the rotating cutters 5, 6, and may clip the claws by driving the rotating cutter 6 by the thumb lever 10. Next, the user may contact the clipped claw with the grinder 22 through the opening 24 of the body 5 and energize the grinder 22 by switching on the switch 26 to polish the sharp claw edges neatly.

According to the above clipper, as shown in FIG. 1, the user grips the body 5 and pushes the thumb lever 10 which slantingly extends from the upper surface of the body 5 only by the force of a thumb. Accordingly, in case of a relatively big animal like a big dog, because the claws are relatively thick or hard, it is laborious to clip the claws by pushing the thumb lever 10 only by the thumb, and the claws are not easily clipped.

According to the above clipper, the claw fragments are held in the head 3 of the body 5, but the claw fragments may escape and be scattered outwardly from the head 3 through the opening 4 through which the thumb lever 10 passes through so that the scattered claw fragments may contaminate the surroundings and may have a bad effect on sanitation and so on. According to the above clipper, the cover 19 for covering the battery chamber 18 also covers the head 3 of the body 5. Accordingly, when the user opens the cover 19 in order to exchange a battery 16, the claw fragments may drop from the head 3 of the body 5 accidentally. Also, when the user opens the cover 19 in order to remove the claw fragments from the head 3, the battery 16 may be dropped.

### DETAILED DESCRIPTION OF THE INVENTION

The invention is created to solve the above described problems and so the object of the invention is to provide a clipper for pet wherein the user may clip the claws of a pet conveniently and safely without the need for exerting relatively strong force and may remove the claw fragments neatly because they may not be discharged while clipping the claws and the surroundings may be kept clear.

According to an aspect of the invention, there is provided a clipper for pet comprising a body having a handle form and a head positioned at a front portion of the body. The body has a claw insertion hole located at one side thereof. A cutting mechanism adjacent the hole has a fixed cutter element inside the head and a movable cutter element inside the head which cooperates with the fixed center element; and a lever connected to the cutter element and pivotally connected to the body for rotation relative to the body. The lever diagonally extends away from the front lower side of the body. An adjustable stop is mounted on the body and is movable to adjust the length a claw may be inserted into the hole.

According to another aspect of the invention, there is provided a clipper for pet with a wall located to one side of the cutter mechanism. The wall partitions the interior of the body such that at least a portion of the cutter elements are isolated in a compartment into which at least the hole extends. There is a movable cover closing at least one side of the compartment.

According to another aspect of the invention, there is provided a clipper for pet comprising a battery chamber inside the body; a motor energizable through a switch by a battery power source; a grinder drivingly connected to the motor 5, with the grinder located at least partly in the body and partially exposed through an opening provided in the body; and a battery chamber cover covering the battery chamber, wherein the battery chamber cover is formed as a separate member from the outlet cover 34 and positioned at the portion of the body located away from the compartment in the head.

### BRIEF DESCRIPTION OF THE DRAWINGS

FIG. 1 is an external view of the prior clipper for a pet.

FIG. 2 is a cross sectional view of FIG. 1.

FIG. 3 and FIG. 4 are respectively a front view and a rear view of the invention.

FIG. 5 is a cross sectional view of the invention.

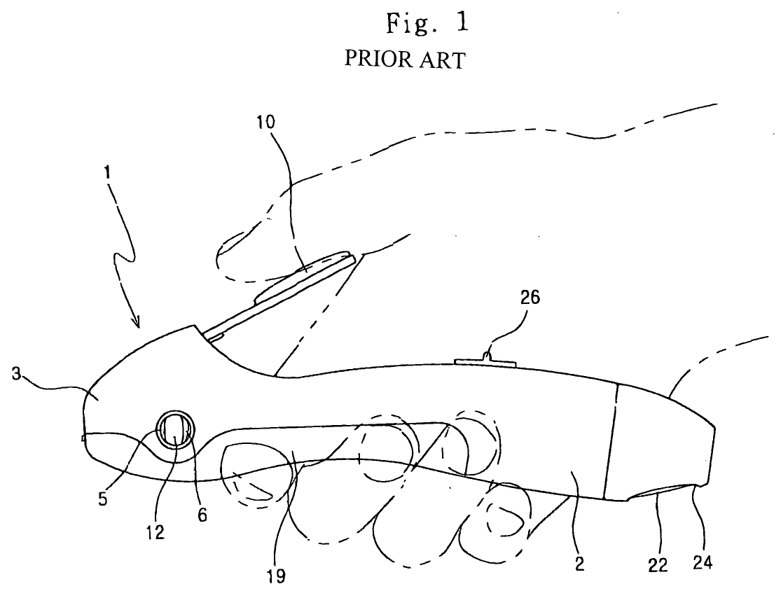

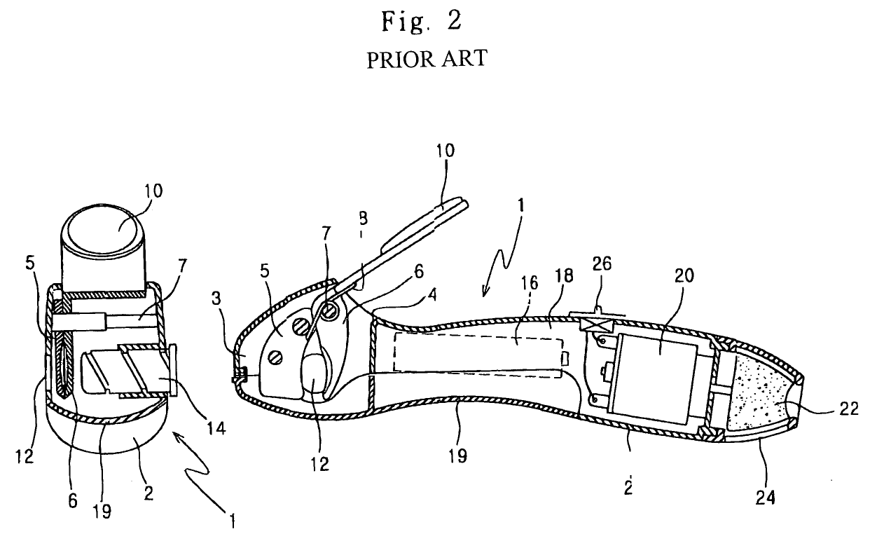

### THE PREFERRED EMBODIMENT OF THE INVENTION

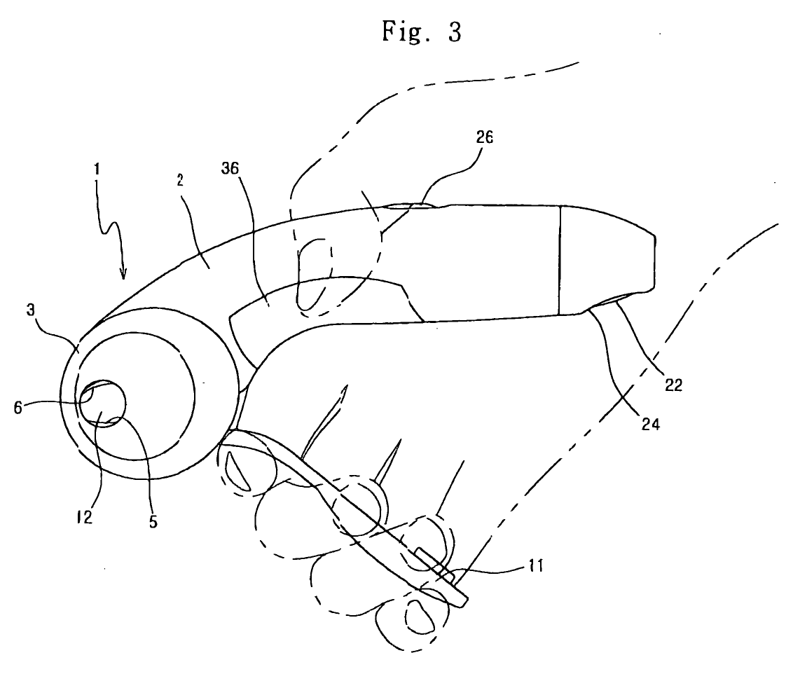

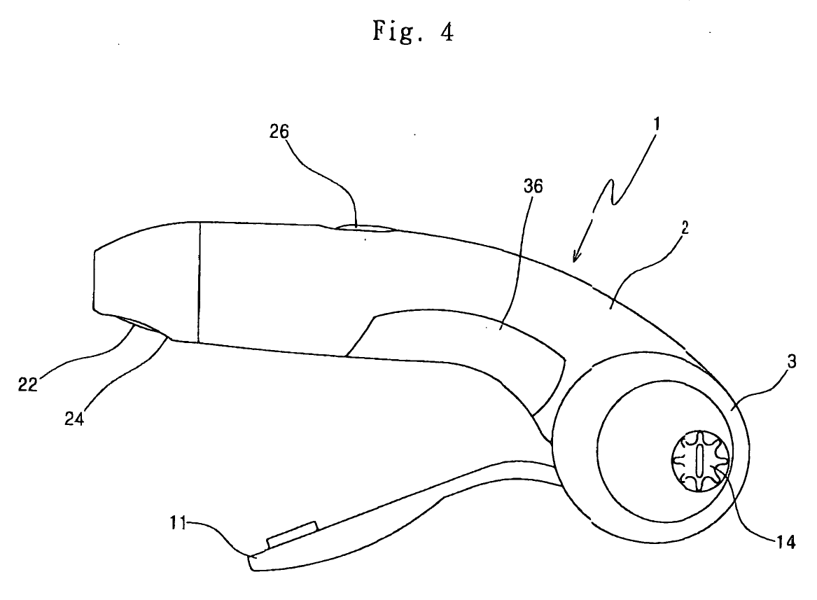

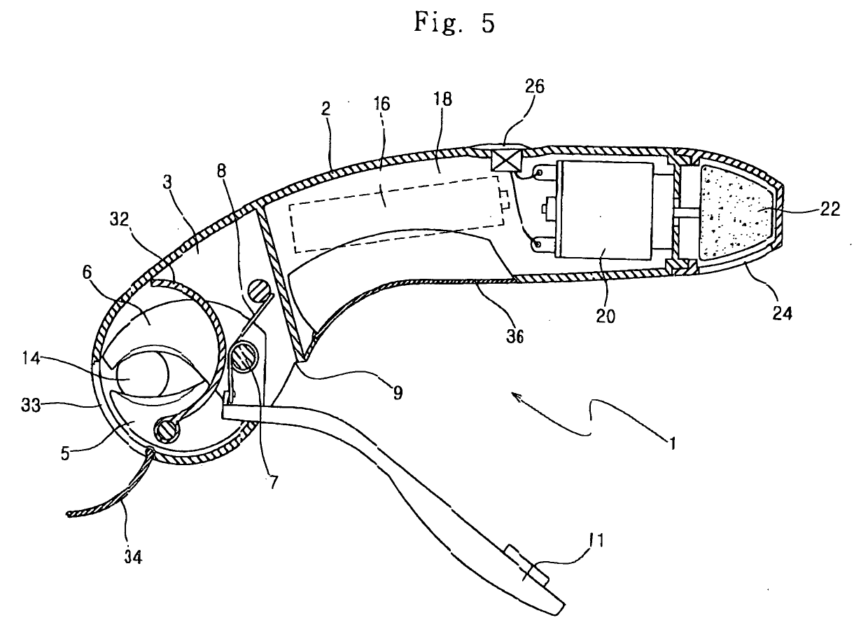

A preferred embodiment of the invention will be described in detail below by referring to the accompanying drawings. FIG. 3 and FIG. 4 are respectively a front view and a rear view of the invention, and FIG. 5 is a sectional view of the invention.

As shown in the drawings, a head 3 of rounded shape is formed at the front end of a body 2 having an elongated handle shaft shape, and a cutting mechanism is mounted in the head 3, which includes a fixed cutter element 5 and a rotating cutter element 6. The rotating cutter 6 is pivotally connected to a hinge shaft 7 and is elastically biased by a spring 8 like 8 torsion spring. A lever 11 is combined at one side of the rotating cutter element 6. The lever 11 diagonally extends toward the lower direction of the body 2 of the handle (i.e., in a direction diagonally sloping away from a lower forward bottom side of the body) through an opening 9 formed at the lower surface of the head 3. Here, because the length of the lever 11 is elongated sufficiently, the user may grip the body 2 with the palm of the hand and may strongly grip the lever 11 with four fingers except for a thumb or with three fingers except for a thumb and a little finger so that he/she may manipulate the lever 11 conveniently.

A claw insertion hole 12 for inserting the claw of a pet is formed at one side of the head 5 in which the fixing and the rotating cutters 5, 6 are mounted. An adjusting bolt 14 for limiting the insertion depth of the claw in the hole is screwed at the other side of the head 3 which is the opposite side to the claw insertion hole 12. If the user operates the adjusting bolt 14 to drive the bolt 14 toward the claw insertion hole 12, the insertion depth of the claw to be contacted at the front end of the adjusting bolt 14 may be shortened. Contrarily, if the user operates the adjusting bolt 14 to retreat the bolt 14 toward the opposite direction to the claw insertion hole 12, the insertion depth of the claw extending to the front end of the adjusting bolt 14 may be lengthened.

A wall 32 for preventing the claw fragments from being scattered outwardly is positioned inside the head 3 of the body 2 to define a cut claw compartment. The partition 32 is adjacent to one side of the cutters 5, 6, and it is positioned at the intermediate portion of the head 3 in order to partition the opening 9 where the lever 11 is passed from the blade portion of the cutters 5, 6. An outlet 33 for the compartment and an outlet cover 34 for discharging the claw fragments are positioned at the front periphery of the head 3. Accordingly, the claw fragments will not be scattered through the opening 9 formed at the rear portion of the head 3 because the opening 9 of the head 3 will be blocked by the partition 32 while clipping the claws. Whenever necessary, the user may remove the claw fragments through the outlet 33 by opening the outlet cover 34.

A battery chamber 18 which is partitioned from the head 3 is formed at the center of the body 2, and a battery 16 is detachably inserted into the battery chamber 18. A motor 20 is positioned at one side of the battery chamber 18 and a grinder 22 in body 2 is connected to the shaft of the motor 20. Because the grinder 22 is partially exposed through the opening 24 formed at the rear end of the body 2, the user may grind the claws of the pet and finish the sharp claw edges neatly. The motor 20 may be driven when the electric power is turned on by the switch 26 mounted at the upper side of the body 20. Here, the battery cover 36 is mounted at the portion outside the head 3. Accordingly, when the user opens the battery cover 36, the claw fragments in the head 3 will not drop outside the head 3.

### INDUSTRIAL APPLICABILITY

According to the above described invention, the lever slantingly extends toward the lower direction of the body and the user may grip the lever with four fingers except for a thumb or with three fingers except for a thumb and a little finger. Accordingly, the invention has the advantage that the user may easily grip the lever and may apply relatively strong grip force to the lever so that he/she may manipulate it easily and may conveniently clip even relatively thick or hard claws of a relatively big animal like a big dog. A wall is positioned between the blade portion of the cutters and the rear opening of the head through which the lever extends so that the blade portion of the cutters and the opening may be blocked by the partition. Accordingly, the invention has the advantage that, because the claw fragments may be blocked by the partition while clipping the claws, the claw fragments are not scattered through the opening of the head, which is helpful for sanitation and the environment.

An outlet and an outlet cover for removing the claw fragments are formed at the front portion of the head, and the battery cover for covering a battery chamber is positioned at the portion which is outside the compartment of the head. Accordingly, the invention has the advantage that the user may separately remove the claw fragments or the battery whose life span has been expired so that the user may use conveniently.

1-3. (canceled)

4. A claw clipper for a pet comprising:
a body having an elongate handle form;
a head positioned at a front portion of the body and having a claw insertion hole located at one side of the head;
a cutting mechanism adjacent the hole having a fixed cutter element inside the head and a movable cutter element inside the head which cooperates with the fixed cutter element;
a lever connected to the movable cutter element and pivotally connected to the body for rotation relative to the body said lever diagonally extending away from a lower side of the body; and
an adjustable stop mounted on the body at the head and movable to adjust the length a claw may be inserted into the hole.

5. A claw clipper for a pet according to claim 4,
including a wall located to one side of the cutter mechanism, said wall partitioning the interior of the body such that at least a portion of the cutter elements are isolated in a compartment into which the hole extends; and
a movable cover closing at least one side of said compartment.

6. A claw clipper for a pet according to claim 4, comprising:
a battery chamber inside the body;
a motor energizable through a switch arranged to control a battery power source locatable in the battery chamber;
a grinder drivingly connected to the motor, said grinder located at least partly in the body and partially exposed through an opening provided in the body; and
a battery chamber cover covering the battery chamber, said battery chamber cover being formed as a separate member from the outlet cover 34 and positioned at a portion of the body separated from the compartment in the head by said wall.
